(19) United States
(12) Patent Application Publication
(10) Pub. No.: US 2020/0091618 A1
(43) Pub. Date: Mar. 19, 2020

(54) LOW PROFILE, ULTRA WIDEBAND, AND/OR OMNIDIRECTIONAL ANTENNAS

(71) Applicant: Laird Technologies, Inc., Chesterfield, MO (US)

(72) Inventors: Kok Jiunn NG, Teluk Intan (MY); Wei Tat NG, Sungai Petani (MY)

(21) Appl. No.: 16/568,650

(22) Filed: Sep. 12, 2019

Related U.S. Application Data
(60) Provisional application No. 62/731,428, filed on Sep. 14, 2018.

(51) Int. Cl. H01Q 21/06; H01Q 1/42; H01Q 1/48; H01Q 1/52; H01Q 21/28; H01Q 9/04

(52) U.S. Cl. CPC H01Q 21/065; H01Q 1/42; H01Q 1/48; H01Q 9/045; H01Q 21/28; H01Q 9/0421; H01Q 1/521

(57) ABSTRACT

According to various aspects, exemplary embodiments are disclosed of antennas, which may be configured to be low profile, ultra-wideband, and/or omnidirectional. In an exemplary embodiment, an antenna may be low profile and may be configured to be operable omnidirectionally within an ultra-wideband frequency range including frequencies from about 350 megahertz to about 6000 MHz. The antenna may include a printed circuit board (PCB) having a first side and a second side opposite the first side. The first side of the PCB may include a radiating element, a first patch with an additional radiating arm, a shorting line, a stub along the shorting line, and a microstrip line. The second side of the PCB may include a ground plane and a second patch.

### CROSS-REFERENCE TO RELATED APPLICATION

This application claims the benefit of and priority to U.S. Provisional Patent Application No. 62/731,428 filed Sep. 14, 2018. The entire disclosure of the above application is incorporated herein by reference.

### FIELD

The present disclosure generally relates to antennas that may be low profile, ultra-wideband, and/or omnidirectional.

### BACKGROUND

This section provides background information related to the present disclosure which is not necessarily prior art.

For in-building cellular network applications, certain applications require a single-input single-output (SISO) antenna that is ultra-low profile and that is aesthetic looking for the building ceiling. Conventional SISO antennas tend to have a high profile. To reduce the profile, wide or bow tie antennas may be used. But then the antenna may be too large in size and have very deep null at low band.

Conventional SISO antennas have been traditionally designed as a dipole parallel to the ceiling, but this may have a very deep null and not be omnidirectional in the azimuth plane. Also, conventional symmetrical dipole designs may be limited in terms of size and radiation pattern options. Thus, it is challenging to design an SISO antenna with ultra-wideband performance (e.g., from 350 MHz to 6000 MHz, etc.) while at the same time reducing the deep null effect due to the conventional symmetrical dipole design especially for the cellular band and reasonable radiation properties up to the 6 GHz band.

### DRAWINGS

The drawings described herein are for illustrative purposes only of selected embodiments and not all possible implementations, and are not intended to limit the scope of the present disclosure.

FIG. 1 illustrates a conventional 2D discone antenna.

FIG. 2 illustrates an antenna having a single PCB (printed circuit board) construction according to an exemplary embodiment in which the antenna is low profile, ultra-wideband, and omnidirectional.

FIG. 3 illustrates an antenna having a PCB and aluminum foil on plastic film construction according to an exemplary embodiment in which the antenna is low profile, ultra-wideband, and omnidirectional.

FIG. 4 is a top view of the PCB layout of the antenna shown in FIG. 2, and illustrating the radiator design including a radiating element, a second patch radiating element with an additional radiating arm to lengthen or increase the electrical length of the antenna, a stub, shorting line, and a microstrip line between the feed point of the antenna and feed point for the cable (or other feed). FIG. 4 also shows the tapering width of the microstrip line from a larger width at the feed point for the cable to the feed point of the antenna.

FIG. 5 is a bottom view of the PCB layout of the antenna shown in FIG. 2, and illustrating the radiator design including patch radiating elements and a feed point for the cable (or other feed).

FIGS. 6 and 7 illustrate an example transformation from a single PCB construction shown in FIG. 2 to a hybrid construction shown in FIG. 3 according to exemplary embodiments, where the transformation may reduce size for cost reasons and with part of the traces overlapping with the aluminum foil. The dimensions in millimeters, weights in ounces, and specific materials (e.g., aluminum, PET (polyethylene terephthalate), etc.) are provided as examples only according to an exemplary embodiment.

FIG. 8 illustrates the PCB of the antenna shown in FIG. 3 adhered to a plastic sheet with aluminum tape according to an exemplary embodiment.

FIG. 9 illustrates the plastic sheet with aluminum tape shown in FIG. 8.

FIG. 10 is an exploded perspective view of the antenna shown in FIG. 3, and illustrating a radome, aluminum foil with plastic film, low PIM PCB, baseplate, low PIM cable, heat shrink tube, and low PIM connector according to an exemplary embodiment.

FIGS. 11 through 14 illustrate the antenna shown in FIG. 10 after the various components have been assembled. The aluminum foil with plastic film and low PIM PCB are within an interior space cooperative defined between the baseplate and radome. FIG. 11 shows the antenna installed on a ceiling tile. Exemplary dimensions (in millimeters) are provided in FIG. 14 for purposes of illustration only according to an exemplary embodiment.

FIG. 15 includes an exemplary line graph of Voltage Standing Wave Ratio (VSWR) versus frequency (GHz) from a simulated result study for the antenna shown in FIG. 8 with and without the short and stub. The line graph includes results from a computer simulation for the antenna with both the stub and shorting line (solid line labeled “VSWR1”), with the shorting line only (dashed line labeled “Without Stub”), and with no shorting line or stub (dotted line labeled “Without Short and Stub”). Generally, FIG. 15 shows that having the stub along the shorting line allows the antenna to have a VSWR of less than 2 while operating at lower frequencies (e.g., VSWR of 1.9611 at 380 MHz, etc.).

FIG. 16 includes an exemplary line graph of Voltage Standing Wave Ratio (VSWR) versus frequency (MHz) from a measured result study for the antenna shown in FIG. 8 with and without the short and stub. The line graph includes results measured for the antenna with both the stub and shorting line (solid line labeled “Original”), with the shorting line only (dashed line labeled “Without Stub”), and with no shorting line or stub (dotted line labeled “No Shorting”). In FIG. 16, Spec1, Spec2, and Spec3 respectively correspond to VSWR of 1.6, 2.0, and 2.5. Generally, FIG. 16 shows that having the stub along the shorting line allows the antenna to have a VSWR of less than 2 while operating at lower frequencies.

FIG. 17 includes an exemplary line graph of Voltage Standing Wave Ratio (VSWR) versus frequency (MHz) from a measured result study for the antenna shown in FIG. 8 with and without the additional arm and additional patch. The line graph includes results measured for the antenna with both the additional arm and the additional patch (solid line labeled “Original”), and with no additional patch and no additional arm (dotted line labeled “No_topadd_bot_add”). In FIG. 16, Spec1 and Spec2 correspond to VSWR of 1.6 and 2.0. Generally, FIG. 17 shows that having the additional arm and additional patch allows the antenna to have a VSWR of less than 2 while operating at lower frequencies.

FIG. 18 includes a 3^{rd} PIM (decibels relative carrier (dBc)) with 2×43 dBm Performance Summary Table for ten antenna samples at a UHF frequency of 380 MHz, a low frequency (L) at 700 MHZ, a first high frequency (H1) of 1920 MHz, and a second high frequency (H2) of 2600 MHz. FIG. 18 shows that all of the antenna samples had a consistent low PIM level less than −150 dBc for all four frequencies of 380 MHz, 700 MHZ, 1920 MHz, and 2600 MHz. The quality of materials used for the antenna may help ensure consistent PIM performance.

FIGS. 19 through 21 are exemplary line graphs of PIM (dBc) versus frequency (MHz) measured for a prototype antenna as shown in FIG. 10 at frequencies from 380 MHz to 385 MHz (FIG. 19), from 776 MHz to 786 MHz (FIG. 20), from 1870 MHz to 1910 MHz (FIG. 21), and from 2550 MHz to 2570 MHz (FIG. 22). As shown, the antenna had a low PIM level less than −150 dBC for all four frequency ranges.

FIGS. 23 and 24 are exemplary line graphs of Voltage Standing Wave Ratio (VSWR) versus frequency (MHz) measured for a prototype antenna as shown in FIG. 10 independently and when mounted on an acoustic ceiling tile (FIG. 23) and a hard ceiling tile (FIG. 24)(e.g., calcified mineral ceiling tile). Generally, FIGS. 23 and 24 shows that the antenna had a good VSWR less than 2.0 (Spec1) across from about 350 MHz to about 6300 MHz when mounted on the acoustic ceiling tile or the hard ceiling tile. As shown in FIG. 23, the antenna had a VSWR less than 1.6 (Spec2) for frequencies above about 700 MHz when mounted on the acoustic ceiling tile. As shown in FIG. 24, the antenna had a VSWR less than 1.7 (Spec2) for frequencies above about 1000 MHz when mounted on the hard ceiling tile.

FIG. 25 is an exemplary line graph of Max Gain in decibels relative to isotropic (dBi) versus frequency (MHz) measured for a prototype antenna as shown in FIG. 10.

FIGS. 26 through 51 illustrate radiation patterns (azimuth plane, Phi 0° plane, and Phi 90° plane) measured for a prototype antenna as shown in FIG. 10 at frequencies of about 350 MHz, 380 MHz, 430, MHz, 520 MHz, 600 MHz, 645 MHz, 698 MHz, 850 MHz, 880 MHz, 960 MHz, 1350 MHz, 1550 MHz, 1690 MHz, 1930 MHz, 2130 MHz, 2310 MHz, 2500 MHz, 2700 MHz, 3300 MHz, 3500 MHz, 3800 MHz, 4200 MHz, 4900 MHz, 5150 MHz, 5470 MHz, and 5900 MHz, respectively. Generally, FIGS. 26 through 51 show that the reasonable omnidirectional radiation patterns of the prototype antenna at these various frequencies that fall within an ultra-wideband frequency range including frequencies from 350 MHz to 5900 MHz.

Corresponding reference numerals indicate corresponding (though not necessarily identical) parts throughout the several views of the drawings.

### DETAILED DESCRIPTION

Example embodiments will now be described more fully with reference to the accompanying drawings.

As explained in the background above, it is challenging to design an SISO antenna for ultra-wideband performance (e.g., from 350 MHz to 6000 MHz, etc.) while at the same time reducing the deep null effect of the conventional symmetrical dipole design especially for the cellular band and reasonable radiation properties up to the 6 GHz band. Ultra-wideband (UWB) structures have been considered that are based on the basic discone type antenna structure.

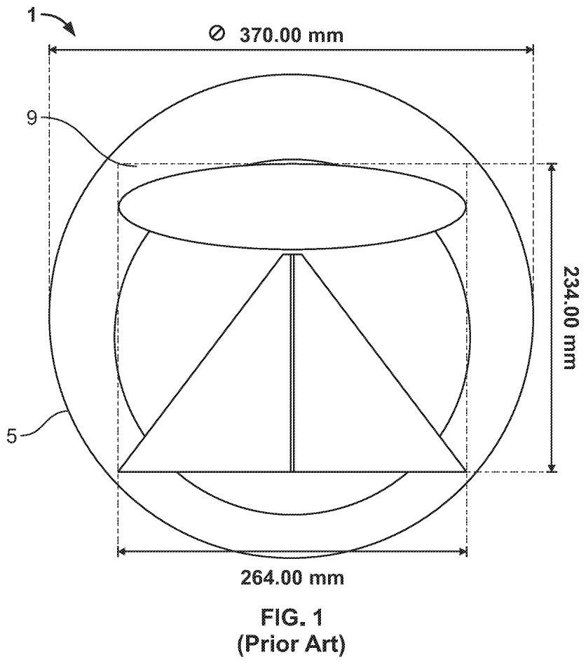

A conventional discone antenna (e.g., a 3D structure discone antenna transferred to 2D structure, etc.) has to be modified in order to meet the 350 MHz band and achieve an ultra-wideband operation from 350 MHz to 6000 MHz. With this antenna modification, the discone antenna 1 required a large radome 5 having a diameter of 370 millimeters (mm) to fit around and cover the printed circuit board (PCB) 9 of the 2D discone antenna 1 as shown in FIG. 1. This 370 mm diameter radome may be too large for certain applications. Also, radiation patterns were mostly very omnidirectional at the plane perpendicular to the PCB plane, which leads to deep null at Phi=90 degree and Phi=270 degree. Additional information about the VSWR and deep nulls of the discone antenna 1 is shown in Appendix A, which is incorporated herein by reference.

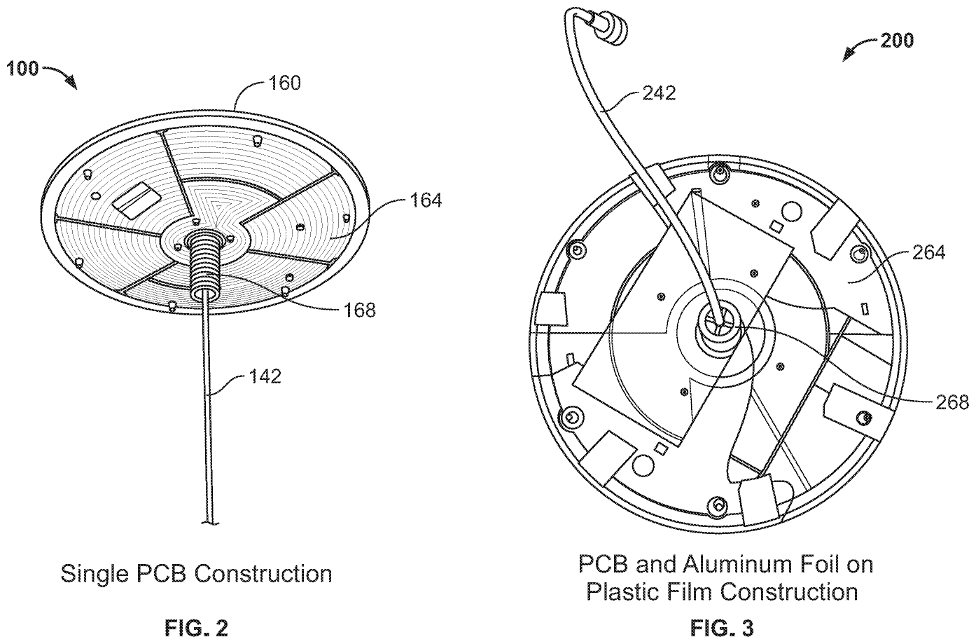

Disclosed herein are exemplary embodiments of antennas (e.g., antenna 100 (FIG. 2), antenna 200 (FIG. 3), etc.) that may configured to be low profile (e.g., radome height of about 7.6 mm or less (FIG. 14), etc.), ultra-wideband (e.g., from about 350 MHz to about 6 GHz, etc.) and/or operable omnidirectional.

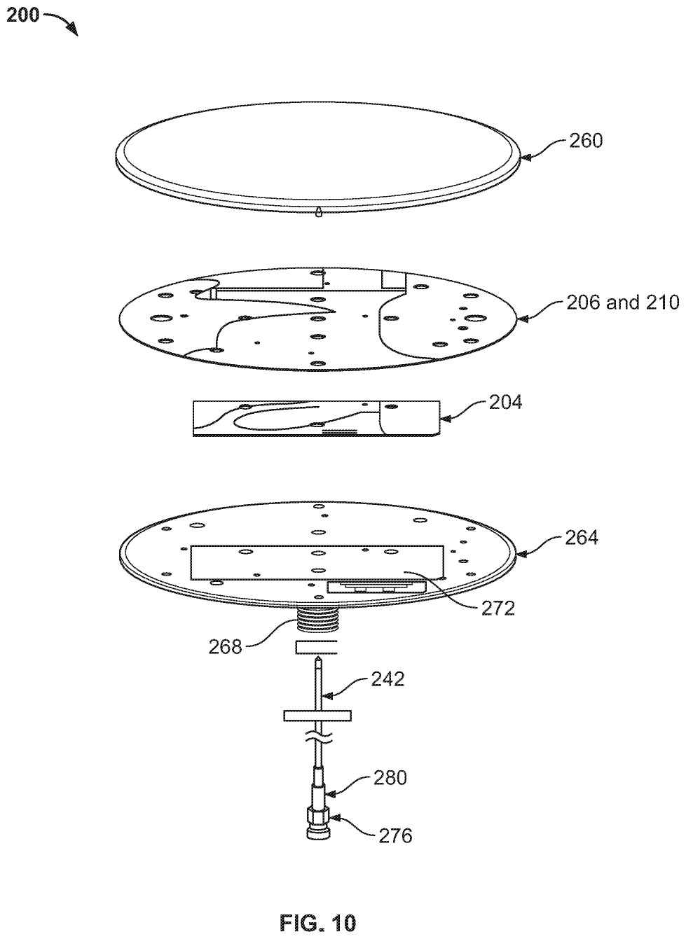

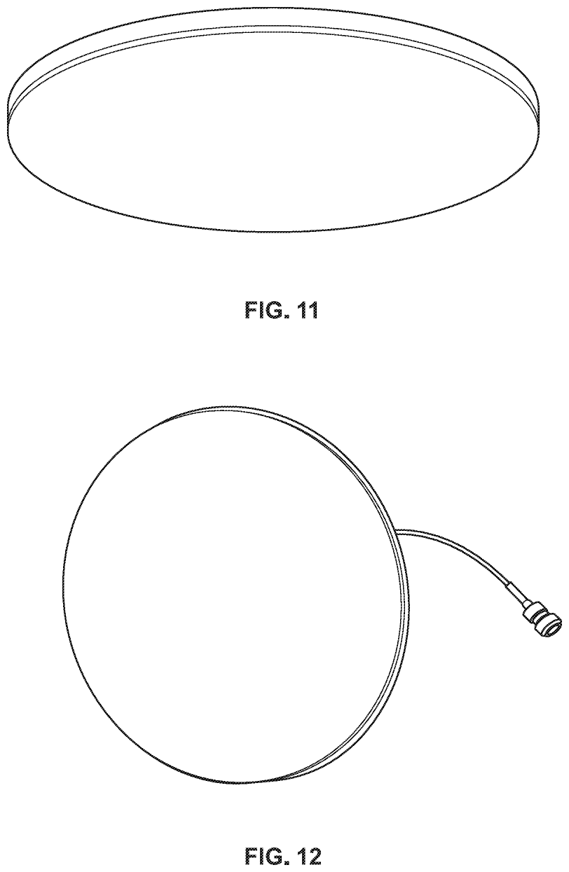

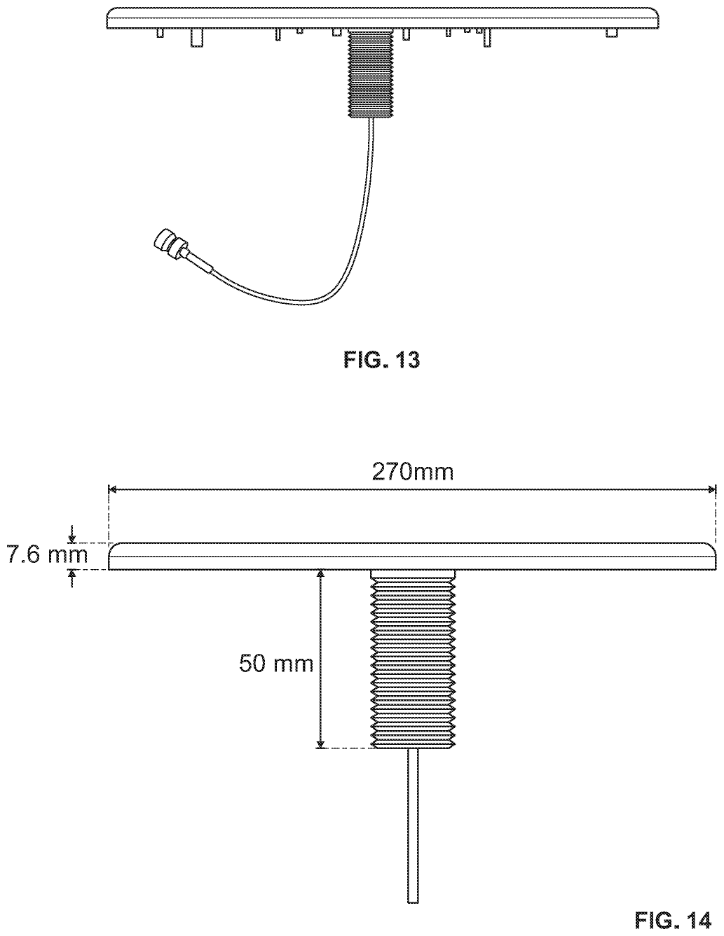

In exemplary embodiments, an antenna generally includes radiators or radiating elements within an interior cooperatively defined between a radome (e.g., a plastic flat circular radome, flat dielectric radome, etc.) and a baseplate or support member (e.g., plastic baseplate, etc.). The baseplate may include a threaded stud feature (broadly, a mounting feature or fixture) for installing the antenna to a ceiling (broadly, a mounting surface). The radome may be configured to be coupled to the baseplate without using metal mechanical fasteners (e.g., FIGS. 10-14, etc.). By way of example, the baseplate and radome may be circular with a diameter of about 270 mm and height of about 7.6 mm (e.g., FIG. 14, etc.).

The radiators may comprise PCB radiators, stamped radiators, flexible PCB (fpcb) radiators, electrically-conductive tape or foil, combination thereof, etc. For example, the radiator and a ground plane (broadly, a ground element) may comprise a flexible trace construction including flexible electrically-conductive traces or materials along opposite first and second (or top and bottom) sides of a flexible PCB (broadly, a substrate). The flexible electrically-conductive materials may comprise metal foil or tape (e.g., aluminum foil or tape, other non-ferromagnetic foils or tapes, etc.) and/or stamped metal (e.g. stamped aluminum, other stamped non-ferromagnetic materials, etc.). An exemplary embodiment may include aluminum tape for adhering the PCB to a dielectric sheet (e.g., plastic sheet, etc.).

In an exemplary embodiment, an antenna may have a single PCB construction including a low PIM (passive intermodulation) rated PCB. See, for example, FIG. 2 showing an antenna 100 that has a single PCB construction.

In another exemplary embodiment, an antenna may have a hybrid or multi-piece construction including a low PIM rated PCB and non-ferromagnetic foil (e.g., aluminum foil, other metal foils, etc.) on a dielectric sheet (e.g., plastic film, etc.) or stamped non-ferromagnetic material (e.g., stamped aluminum, other stamped metals, etc.). The low PIM rated PCB may be relatively small and/or smaller in size than the PCB used for the single PCB construction. See, for example, FIG. 3 showing an antenna 200 that has a PCB and aluminum foil on plastic film construction.

In exemplary embodiments, the antenna may include asymmetrical arms. In which case, the antenna should not be considered a typical dipole antenna having symmetrical arms. The antenna may be considered an asymmetrical arm shorted dipole or a planar shorted discone antenna. The longer/larger asymmetrical arm may be referred to as a ground plane while the other asymmetrical arm may be referred to as the radiator.

Several antenna features may be configured (e.g., modified, etc.) to allow or provide an ultra-wideband antenna that fits within a relatively small radome (e.g., having a diameter of 270 mm or less, etc.) and that has an operating frequency range (e.g., extended down to, etc.) down to 350 MHz with relatively small steps (e.g., miniaturized or reduced steps, etc.). In exemplary embodiments, one or more of the following features may be modified for and/or provided to an antenna:
have a feed point at a top disk offset to non-centered;
add radiator parts having a non-rectangular shape (e.g., generally or substantially elliptical in shape, generally disk shaped, non-circular shape, etc.) with a patch to extend electrical length;
add additional radiator arms along a bottom of a ground plane having a non-rectangular shape (e.g., generally bell-shaped, a curved shape, etc.);
maximize or increase an electrically-conductive foil (e.g., aluminum foil, etc.) to the circumference of the radome;
introduce a shorting line that may have direct coupling or proximity coupling;
   proximity coupling may be realized with additional patch along a top of the ground plane without galvanic contact to the ground plane;
   exemplary embodiments may not include plated thru hole (pth) via, which may otherwise provide a slightly higher risk of PIM (passive intermodulation) level;
   surface patch of the proximity couple may be sufficiently large to enable similar effect of the direct coupling design; and
stub along or at the shorting line (e.g., shorting trace, etc.) may help to maintain good bandwidth at the UHF band.

In exemplary embodiments, contributions to the antenna's ultra-wide bandwidth may include one or more:
Generally elliptical shape for the radiator that provides smooth transition. The arc of the elliptical shaped radiator does not necessarily follow a typical mathematical derived shape but may be an arc that is manually adjusted to suit the available space under the radome.
Wide arm or ground plane of the antenna having a non-rectangular shape (e.g., generally bell-shaped, a curved shape, etc.) and top radiating element having a non-rectangular shape (e.g., generally or substantially elliptical in shape, generally disk shaped, non-circular shape, etc.). This may help the antenna to have a good transition of impedance across a wide frequency range.
Tapering width and length of the transmission line may help on the smoothing impedance of the antenna across a wide frequency range. The trace of the microstrip line may be an arc having sufficient length for the bandwidth and enables the feeding at about a center of the whole antenna structure.

In exemplary embodiments, there are several factors that lower the risk of high PIM level:
using pigtail coaxial cable option instead of a fixed connector may be more difficult to be implemented to the PCB;
perpendicular feeding of the cable;
right soldering pad size for the cable;
using low PIM rated PCB; and
good quality of foil, which may be copper, brass, or aluminum.

In exemplary embodiments, several factors play important roles to have reduced null and more omnidirectional radiation patterns at azimuth plane for horizontal planar asymmetrical dipole antennas as disclosed herein:
ratio of the length between the radiator and the ground plane; and
the length of one of the radiator arms.

Accordingly, disclosed herein are exemplary embodiments of antennas that may have or provide one or more of the following features or advantages over conventional dipole antennas. For example, an antenna disclosed herein may have less null at azimuth plane as compared to a conventional dipole. An antenna disclosed herein may have a wide bandwidth, may enable a stable low PIM product, and/or may have a lower profile as compared to other conventional antennas. An antenna disclosed herein may have a reduced size as compared to a conventional dipole of a UHF band antenna.

With reference now to the figures, FIGS. 2, 4, and 5 illustrate an exemplary embodiment of an antenna 100 embodying one or more aspects of the present disclosure. The antenna 100 may be configured to be low profile and operable omnidirectionally within a ultra-wideband frequency range including frequencies from about 350 MHz to about 6000 MHz.

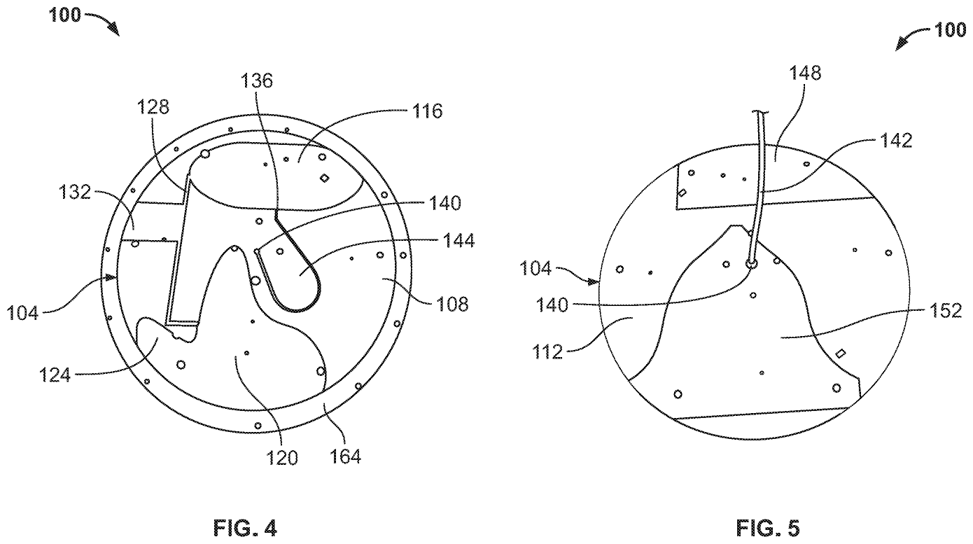

In this exemplary embodiment, the antenna 100 may have a single PCB construction. For example the antenna 100 may include a single low PIM rated PCB 104 having a first or top side 108 (FIG. 4) and a second or bottom side 112 (FIG. 5) opposite the first side 108.

As shown in FIG. 4, the PCB's first side 108 includes a radiating element 116, a patch radiating element 120 with an additional radiating arm 124, a shorting line 128, a stub 132 along the shorting line 128, a feed point 136 for the antenna 100, a feed point 140 for a cable 142 (or other feed), and a microstrip line 144. As shown in FIG. 5, the PCB's second 112 includes a proximity patch 148 and a ground plane 152.

The radiating element 116 (FIG. 4) may be configured to have a non-rectangular shape (e.g., generally or substantially elliptical in shape, generally disk shaped, non-circular shape, etc.). The ground plane 152 (FIG. 5) may be configured to have a non-rectangular shape (e.g., generally bell-shaped, a curved shape, etc.). This may help provide the antenna 100 with a good transition of impedance across a wide frequency range.

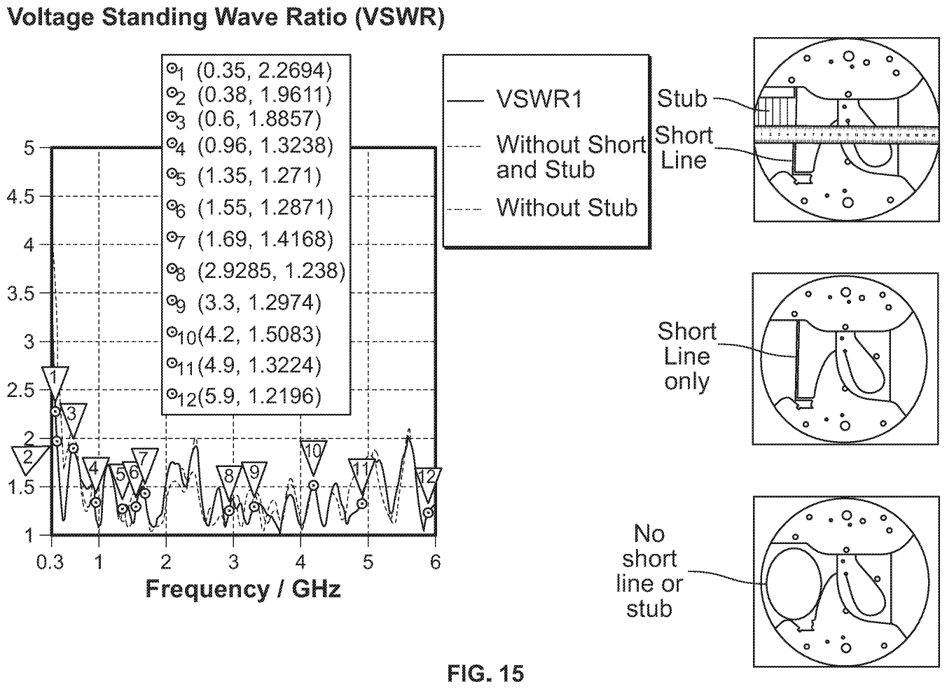

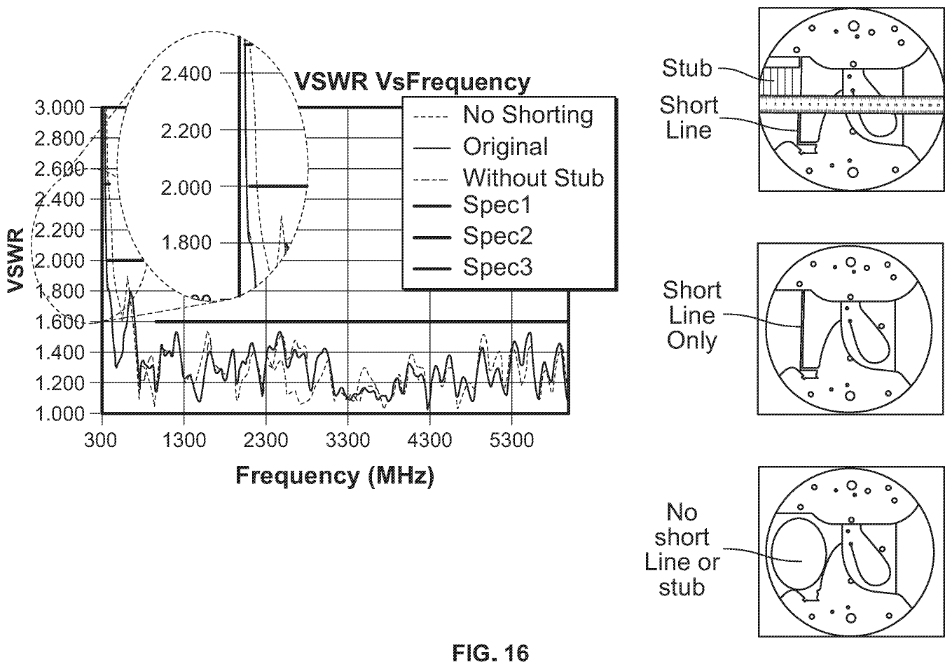

The shorting line 128 (e.g., shorting trace, etc.) extends generally between the radiating element 116 and the patch 120. The stub 132 (e.g., a generally rectangular stub, etc.) is provided along the shorting line 128, e.g., at a location closer to the radiating element 116 than it is to the patch 120. The addition of the stub 132 may help the antenna 100 maintain good bandwidth at the UHF band. See, for example, the line graphs in FIGS. 15 and 16 showing the performance improvement that may be achieved by adding a stub along a shorting line, such that the antenna may have a VSWR of less than 2 while operating at lower frequencies.

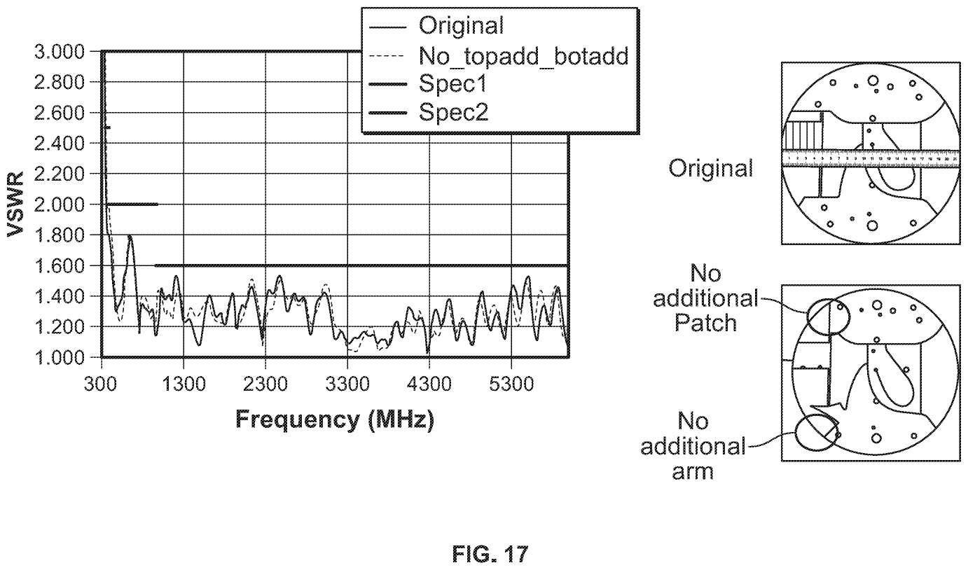

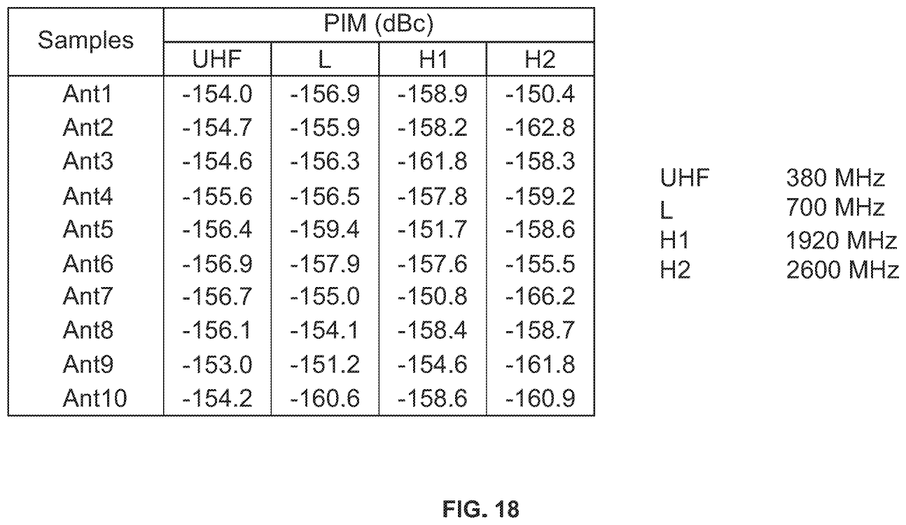

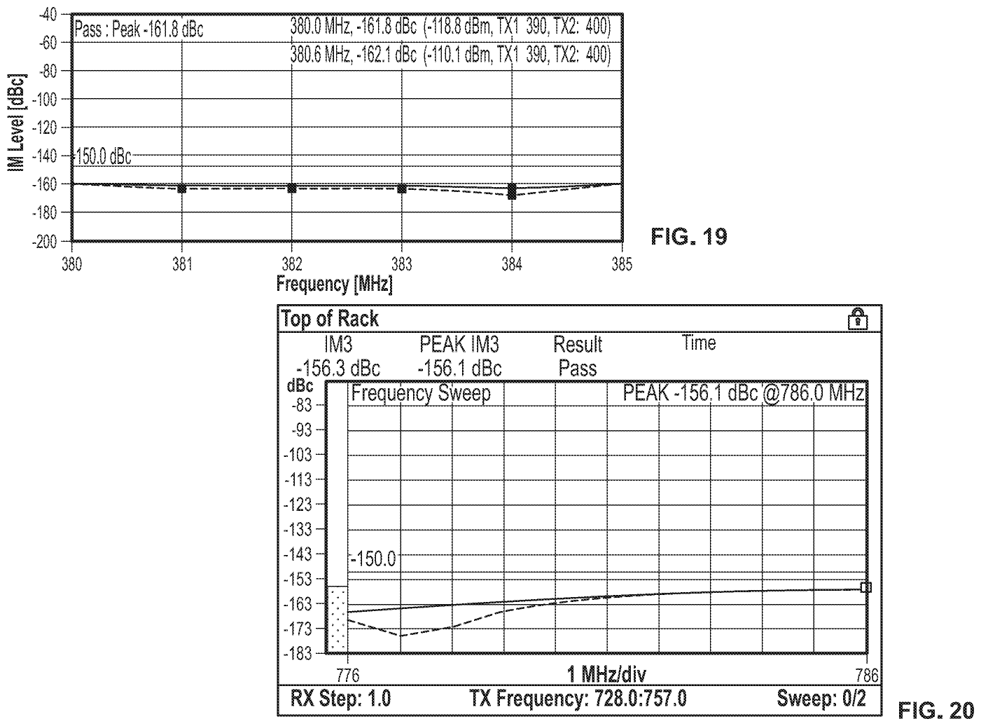

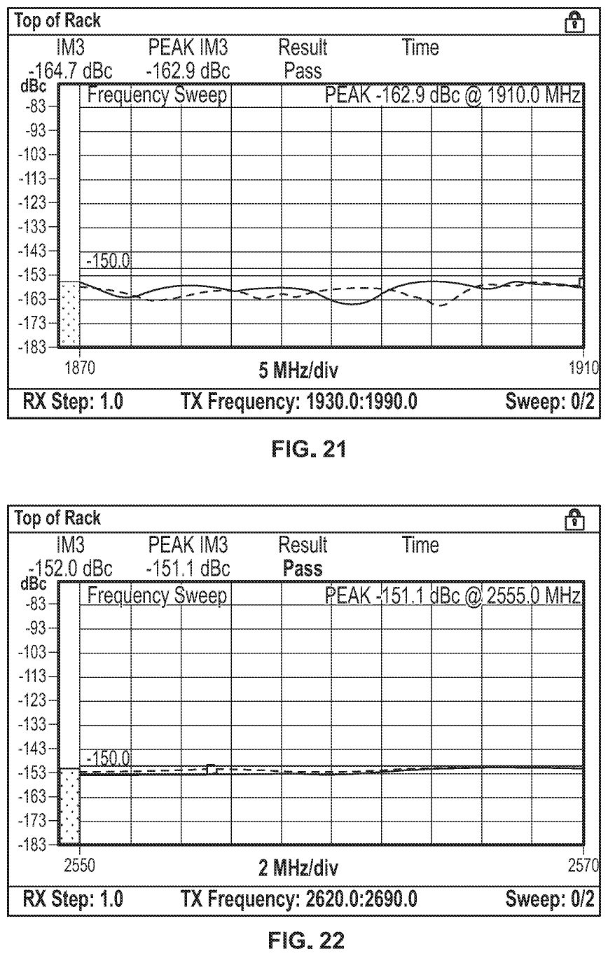

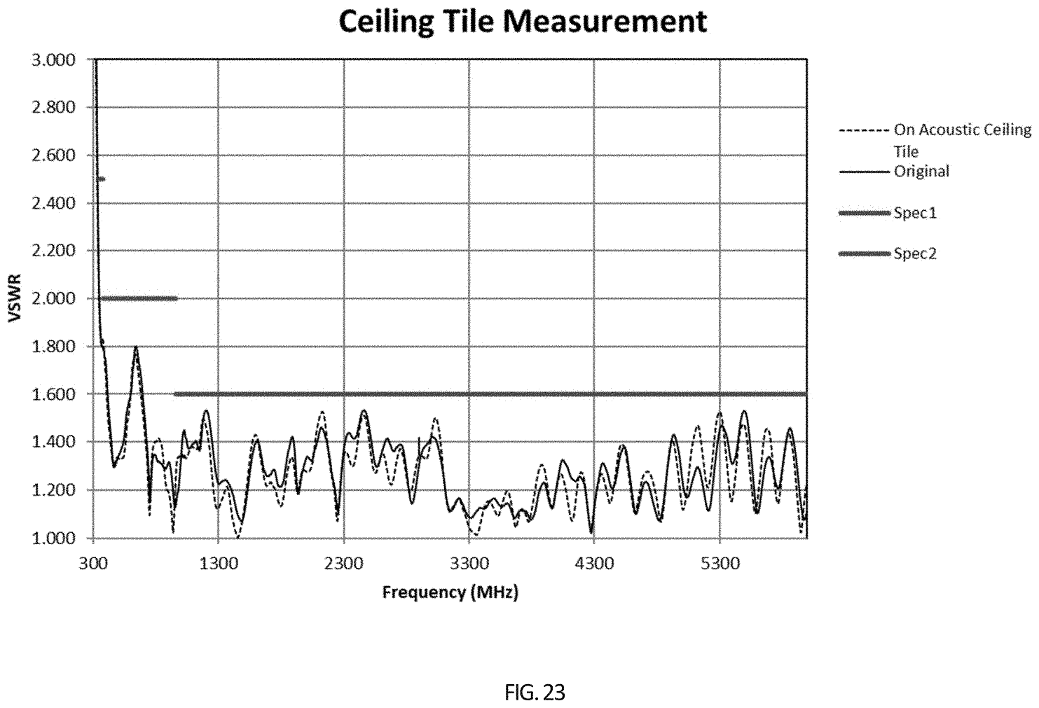

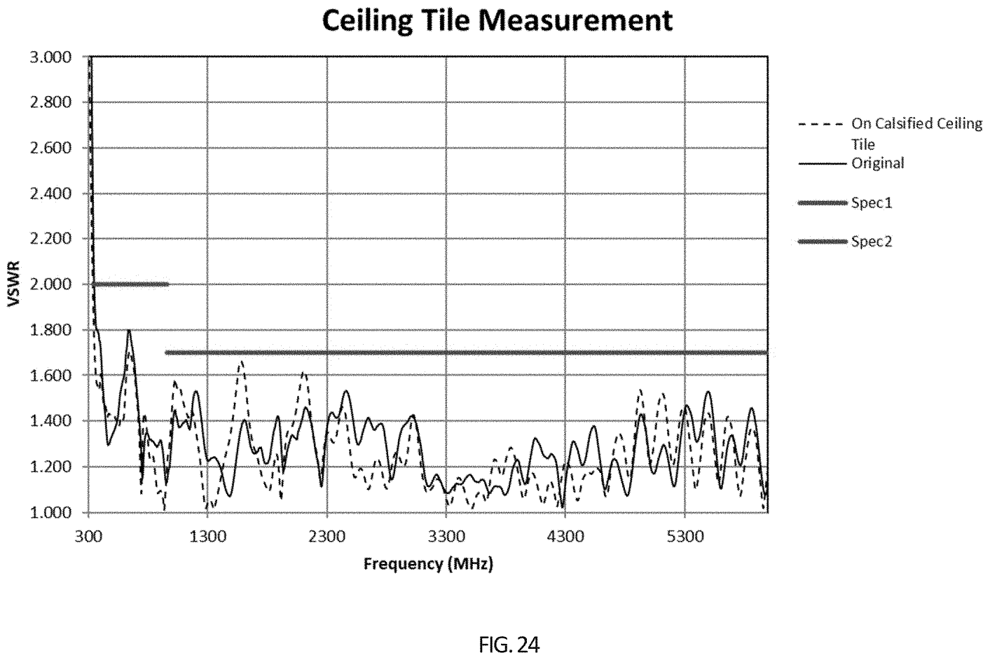

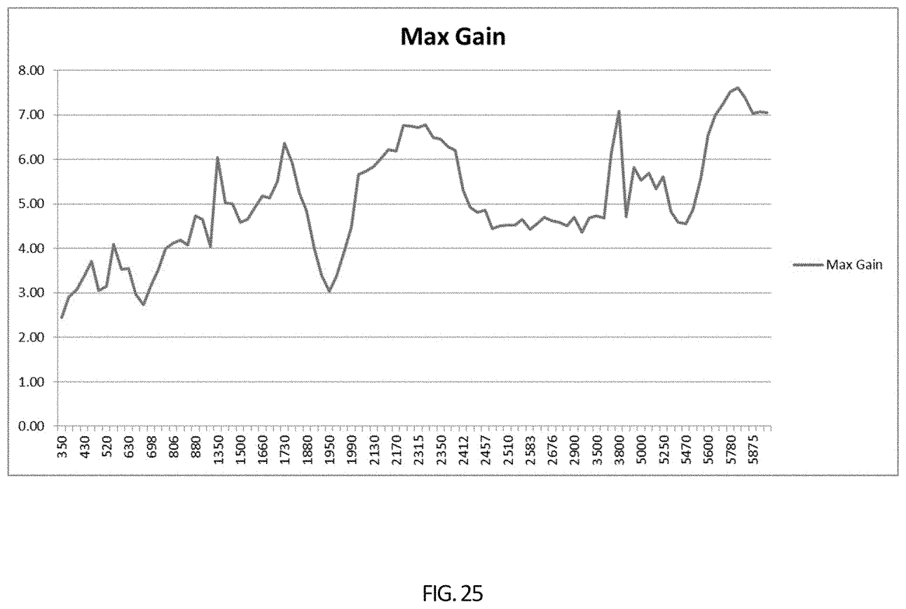

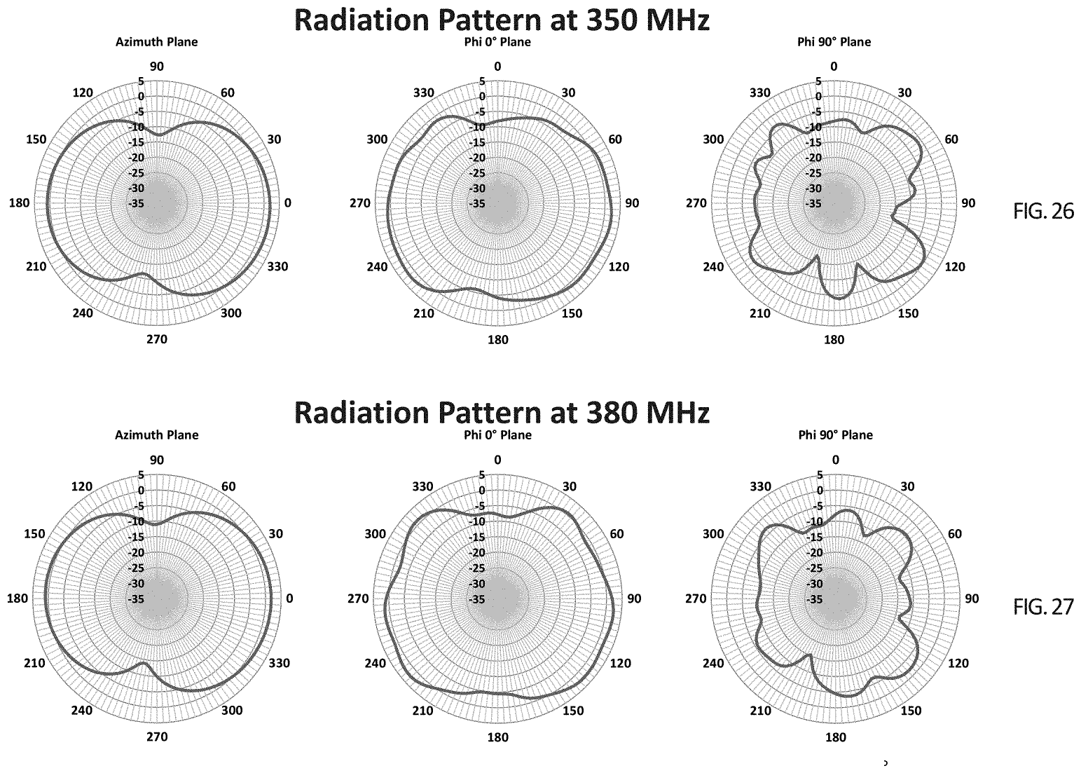

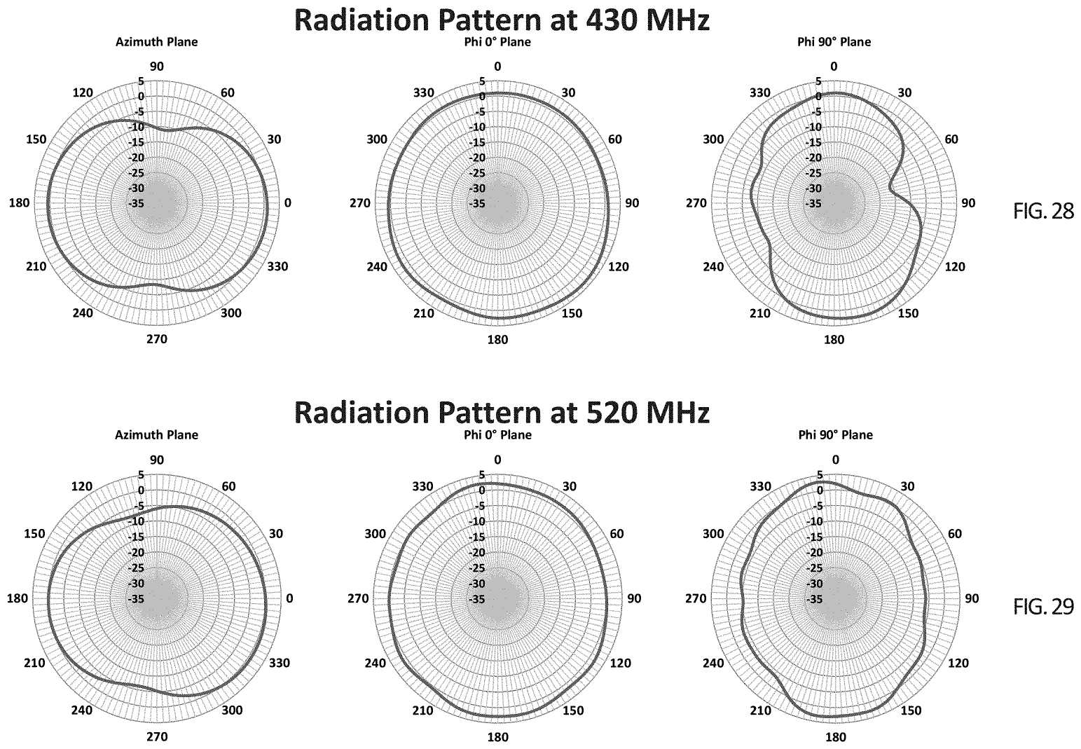

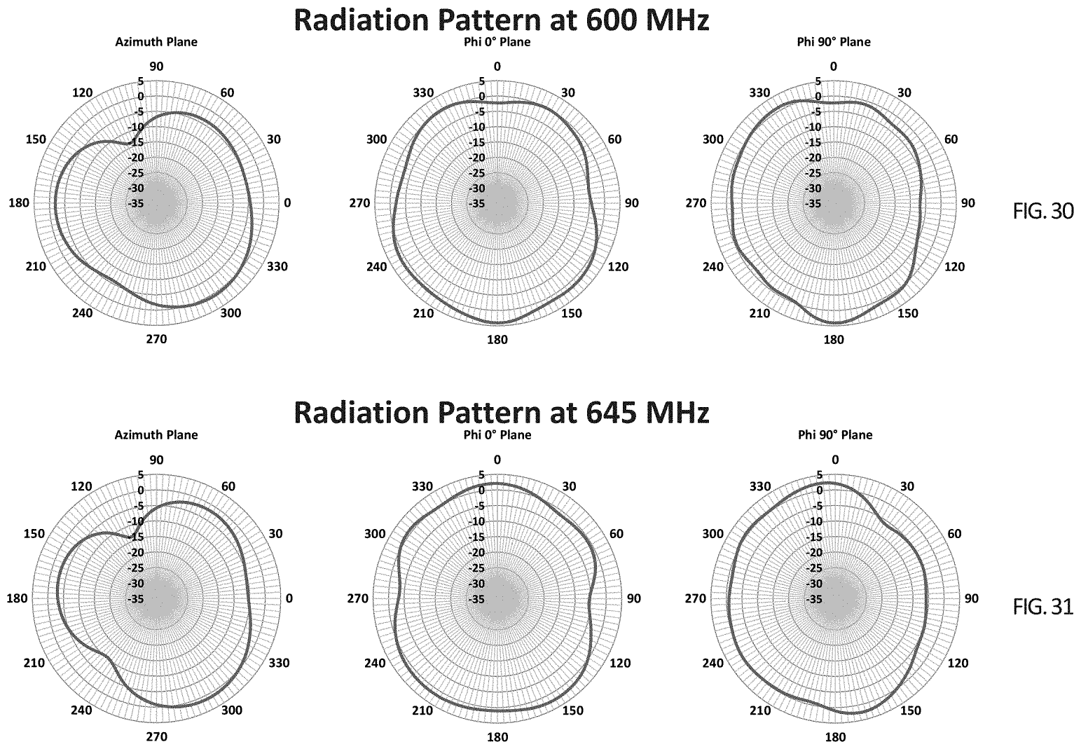

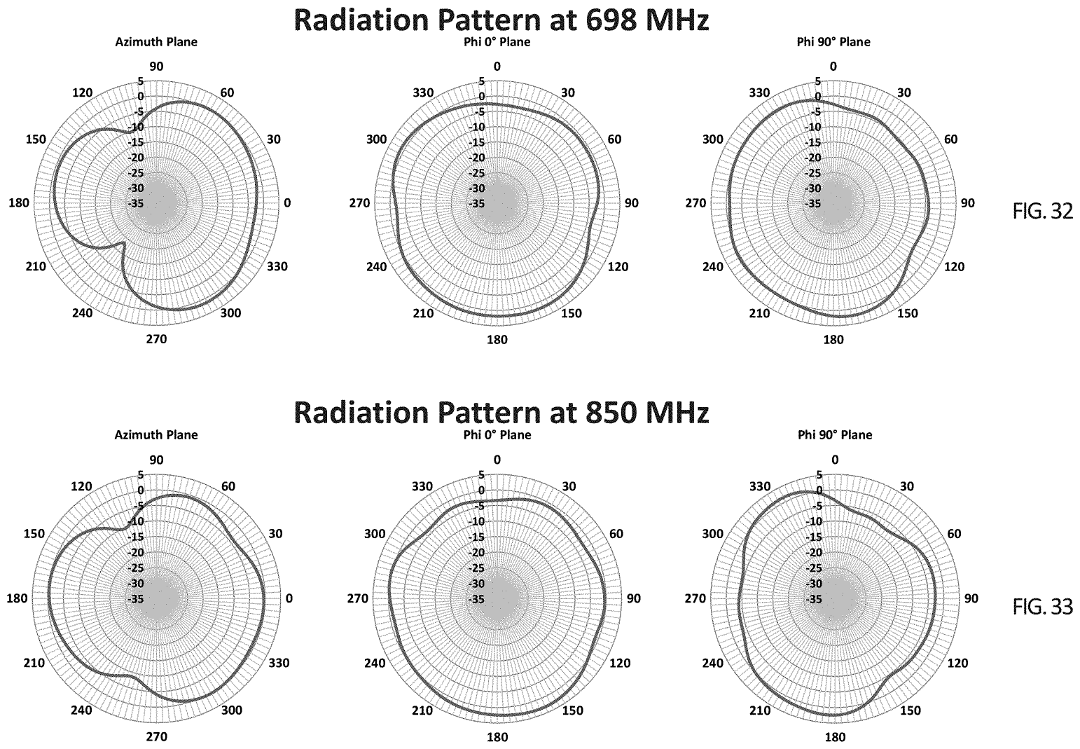

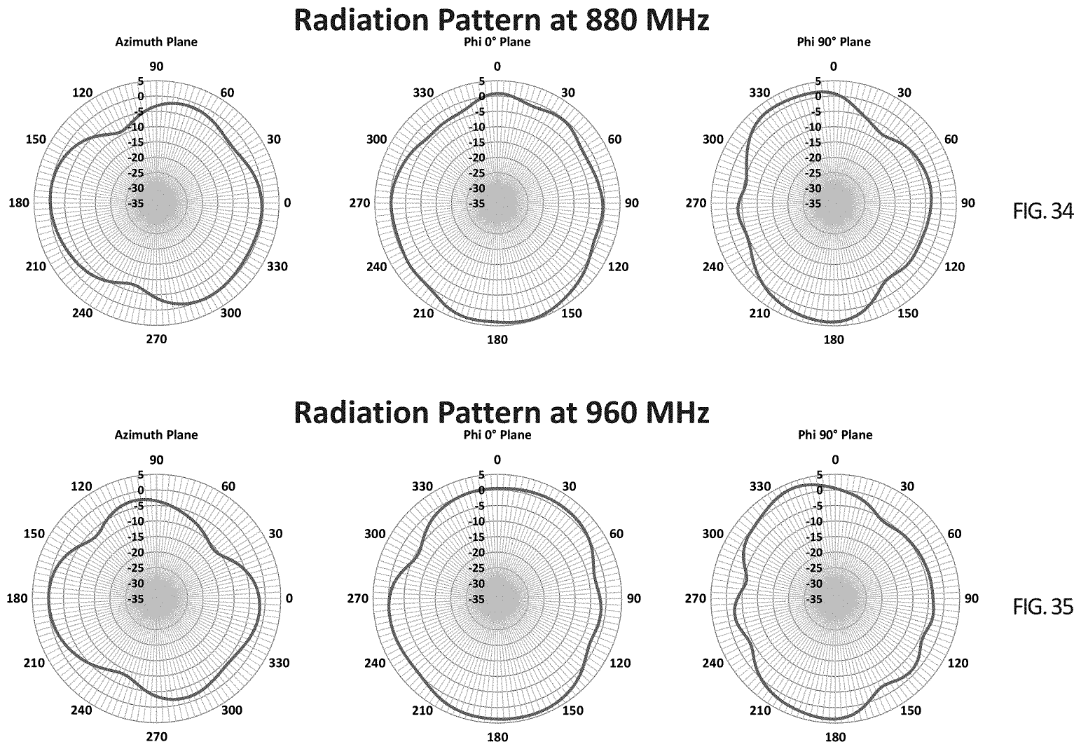

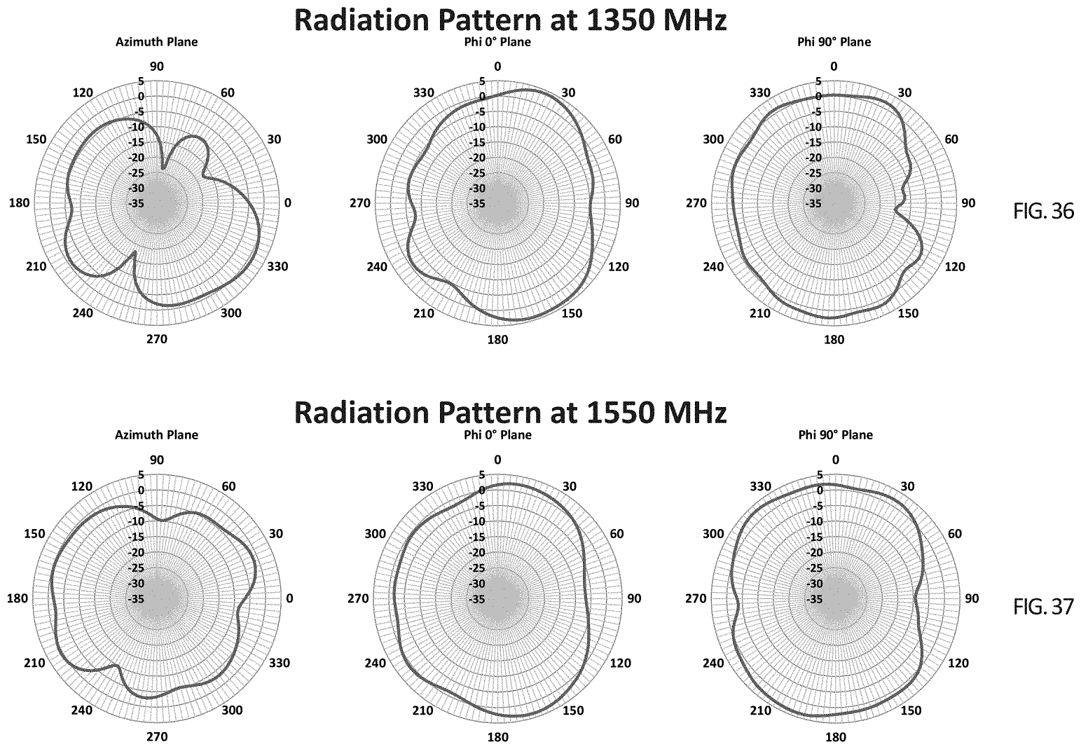

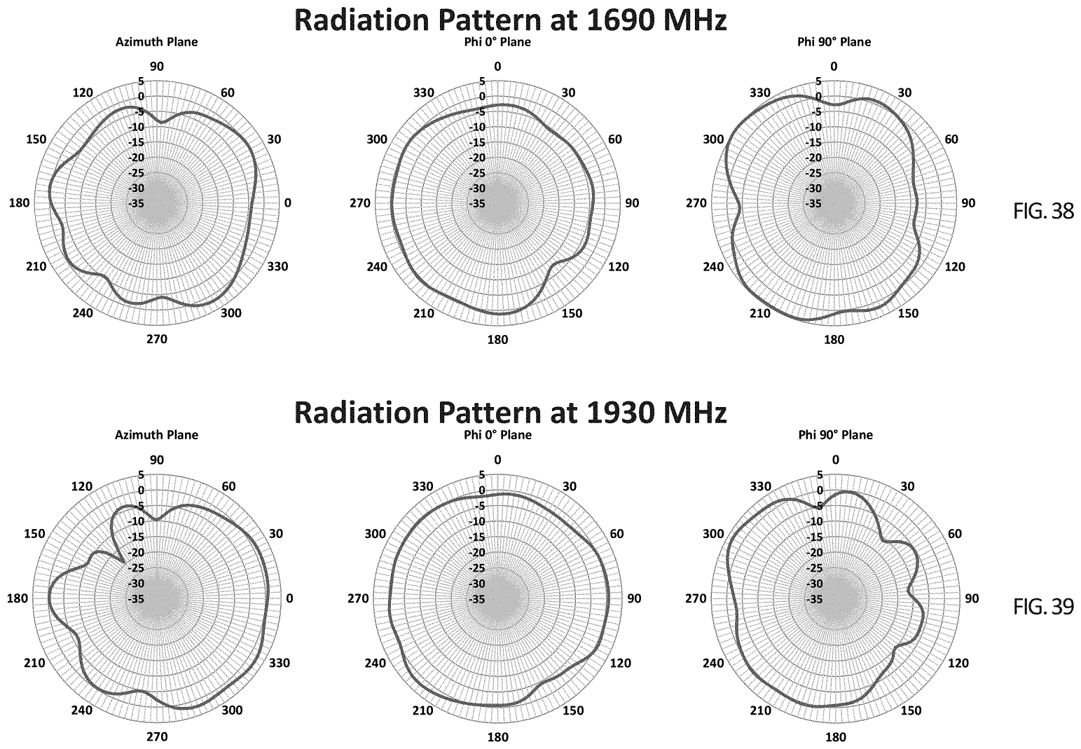

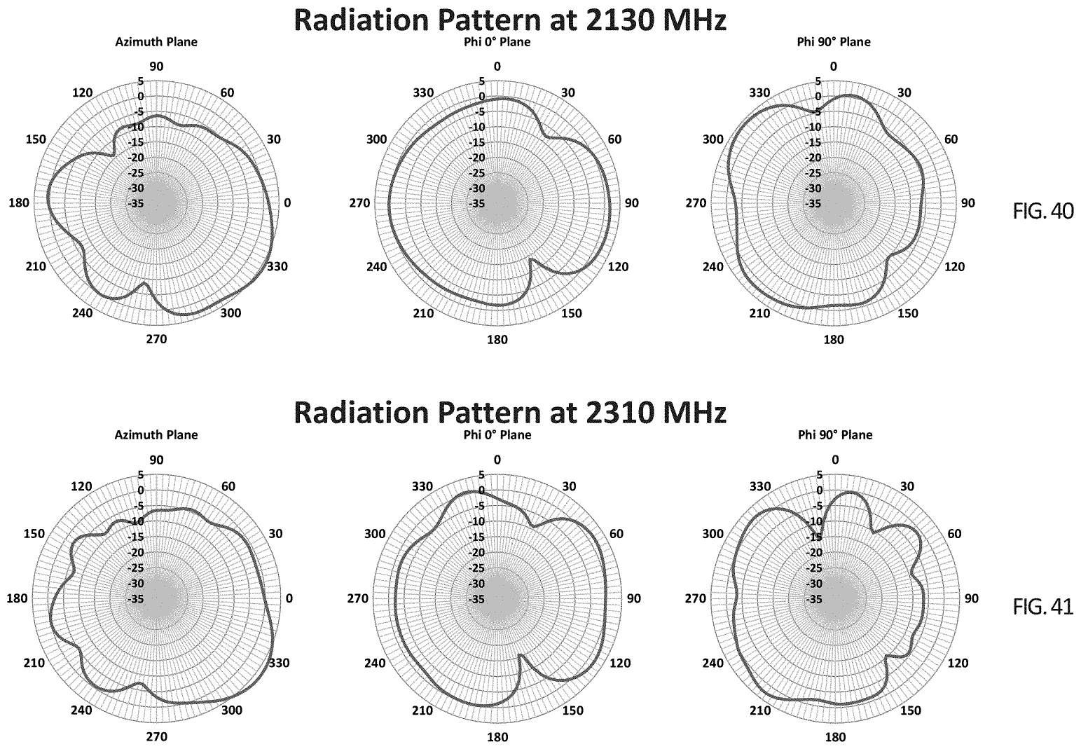

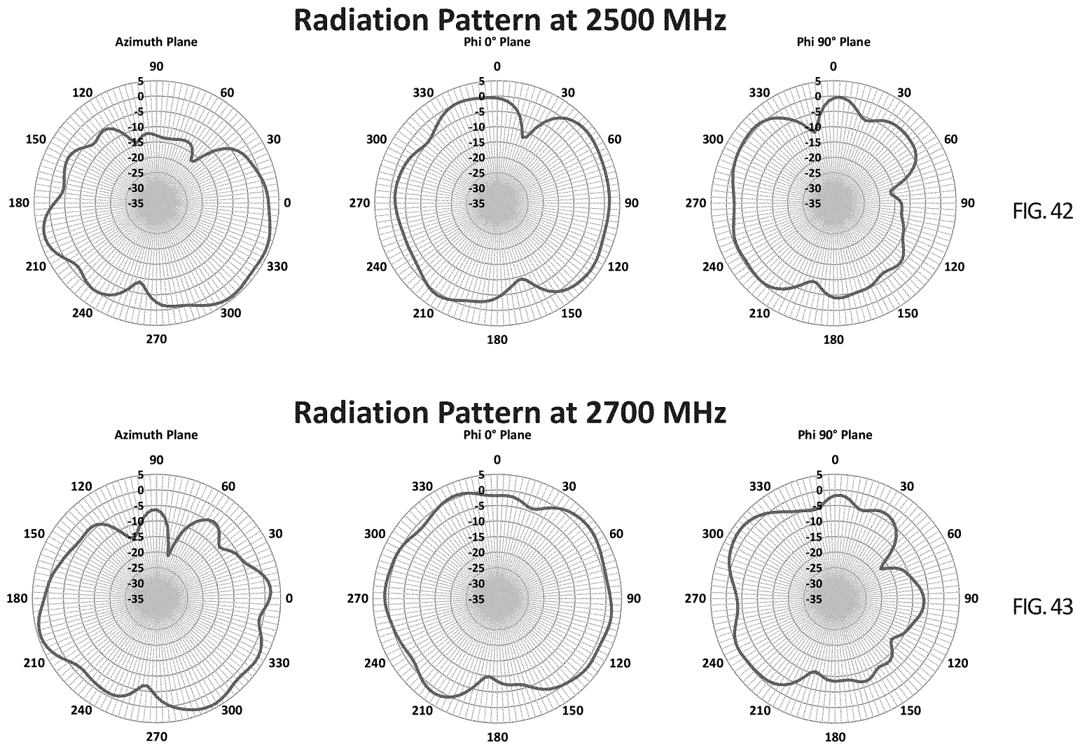

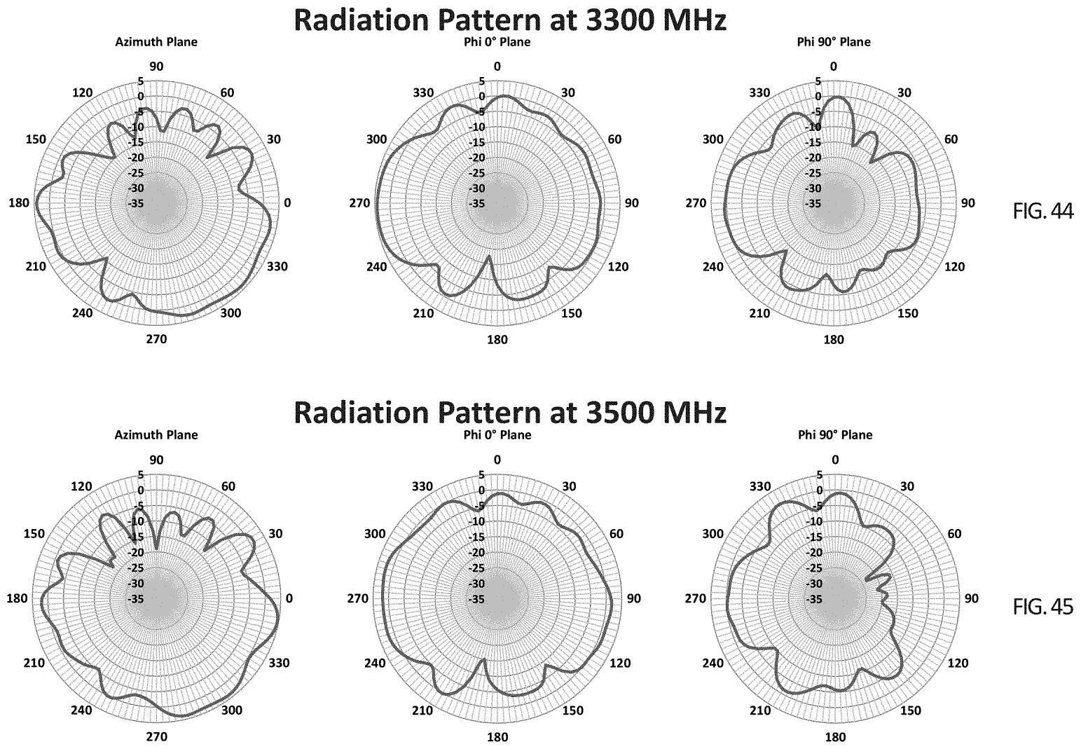

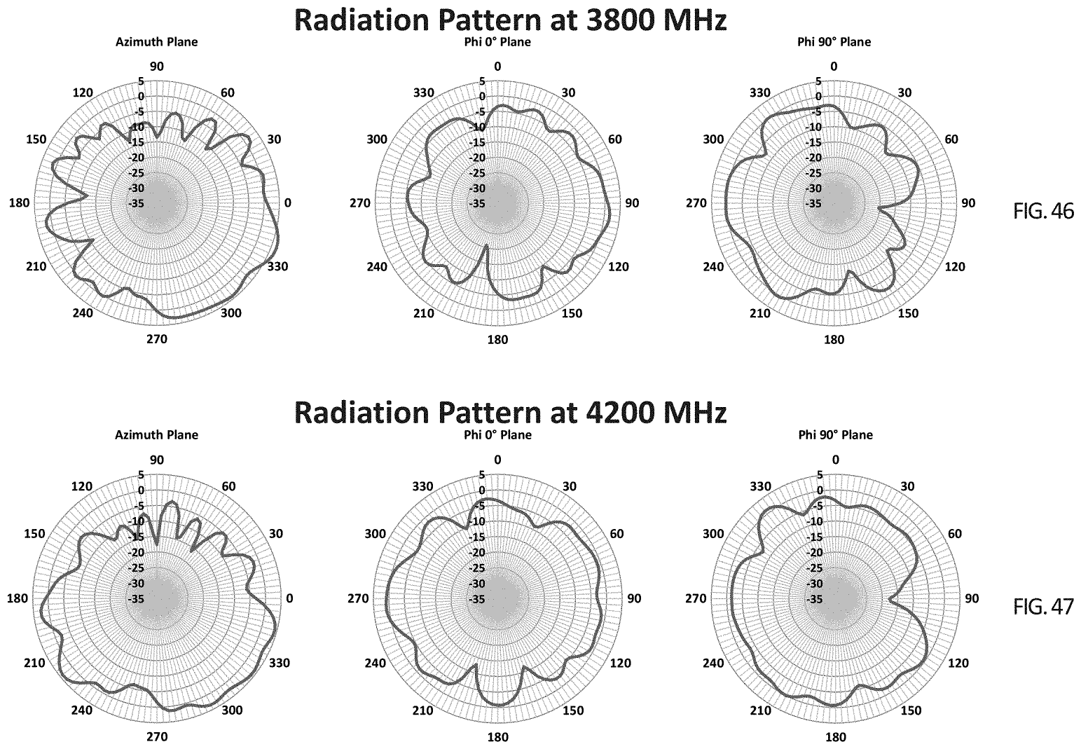

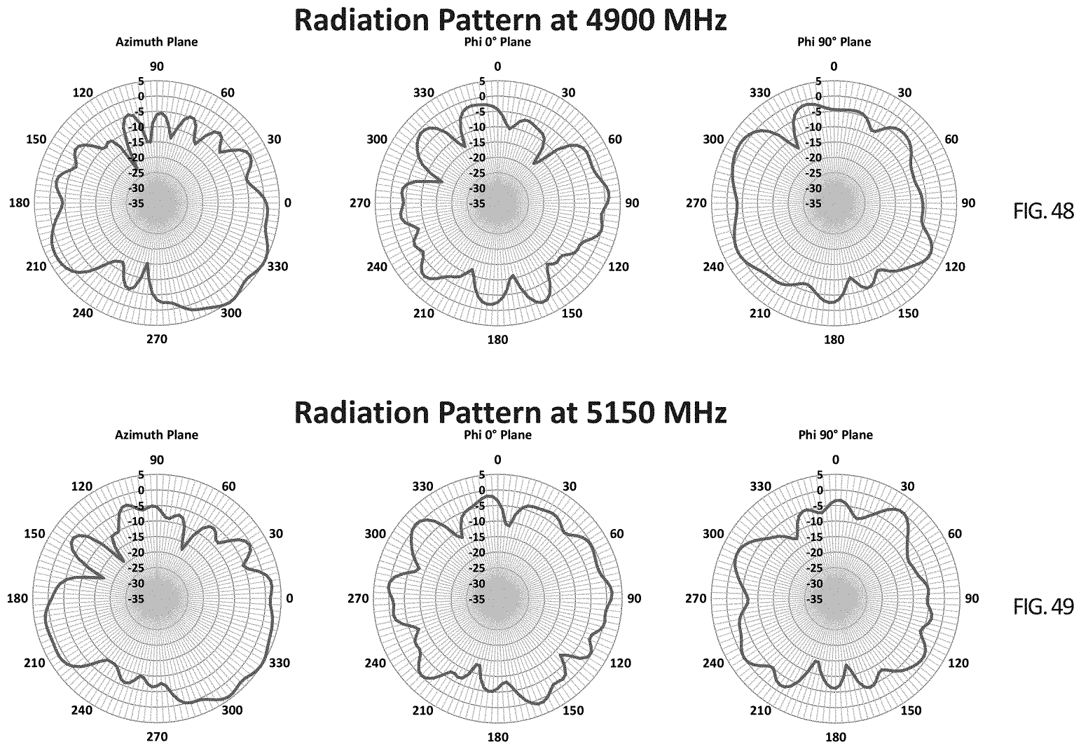

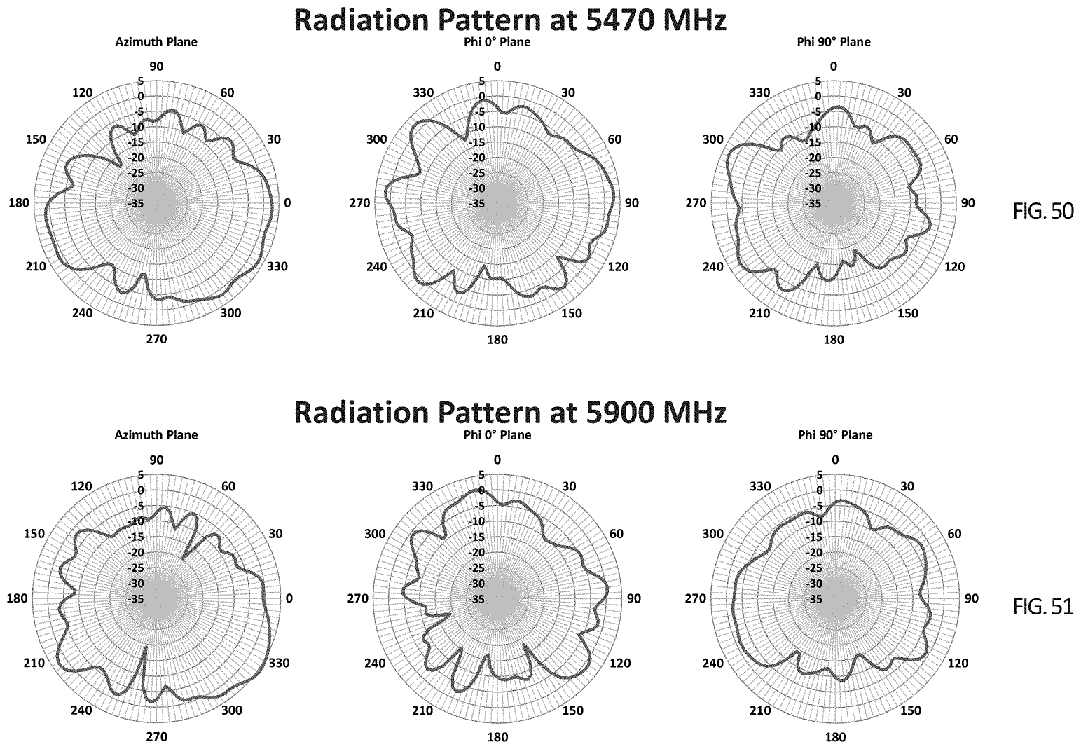

The additional arm or radiating element 124 increases an electrical length of the antenna 100. The antenna 100 also includes the additional proximity patch 148 along the second side 112 of the PCB 100. The additional proximity patch 148 also increases an electrical length of the antenna 100. The addition of the arm 124 and patch 148 may allow the antenna 100 to have a VSWR of less than 2 while operating at lower frequencies, such as shown in FIG. 17.

The microstrip line 144 extends generally between the antenna feed point 136 and the cable feed point 140. The microstrip line 144 is configured such that the microstrip line's width tapers or decreases along the microstrip line 144 in a direction from the cable feed point 140 to the antenna feed point 136. Accordingly, a width of the microstrip line 144 is larger at the cable feed point 140 and smaller at the antenna feed point 136.

The patch 120 may be relatively wide and/or otherwise configured to proximity couple to the ground plane 152 along the PCB's second side 112. In alternative embodiments, the patch 120 may be replaced by a plate thru hole (PTH), which may a higher risk of a higher PIM level if the PTH quality is not consistent. Without changing the wide patch 120, a PTH may also be introduced at a certain location if a DC short is needed, which PTH may then have less impact on PIM performance.

Electrically-conductive material (e.g., copper traces, etc.) may be provided or disposed along the first side 108 to thereby define or provide the electrically-conductive surfaces or components 116, 120, 124, 128, 132, 136, 140, 144, 148, and 152 along the first and second sides 108, 112 of the PCB 100. Additionally, or alternatively, metal foil or tape (e.g., aluminum foil or tape, other non-ferromagnetic foils or tapes, etc.) and/or stamped metal (e.g. stamped aluminum, other stamped non-ferromagnetic materials, etc.) may be used in other exemplary embodiments.

As shown in FIG. 2, the antenna 100 includes a radome or cover 160 (e.g., a plastic flat round or circular radome, etc.) and a baseplate or support member 164 (e.g., plastic baseplate, etc.). FIG. 14 provides exemplary dimensions (in millimeters) that may be used for the radome 160 and baseplate 164. The radome 160 is circular with a diameter of 270 mm and low profile height of 7.6 mm. The baseplate 164 is also circular with a diameter of 270 mm. The dimensions in this paragraph (and elsewhere in this application and the drawings) are provided for purposes of illustration only according to exemplary embodiments as alternative embodiments may be configured differently, e.g., smaller, larger, etc.

The radome 160 and baseplate 164 cooperatively define an interior in which the PCB 104 is positioned as shown in FIG. 2. The baseplate 164 may be configured for holding the antenna components. For example, the baseplate 164 may include protrusions extending upwardly for positioning within corresponding openings in the PCB 104, to thereby align and retain the PCB 104 in place.

The radome 160 and baseplate 164 are configured to protect the PCB 104 and electrically-conductive elements (e.g., radiating element 116, patch 120, additional radiating arm 124, shorting line 128, stub 132, antenna feed point 136, cable feed point 140, microstrip line 144, patch 148, ground plane 152, etc.) from damage, e.g., due to environmental conditions, etc. The radome 160 and baseplate 164 may be formed from a wide range of materials, such as, for example, thermoplastic materials (e.g., polycarbonate blends, Acrylonitrile-Butadiene-Styrene (ABS), Polycarbonate-Acrylonitrile-Butadiene-Styrene Copolymer (PC/ABS) blend, etc.), glass-reinforced plastic materials, synthetic resin materials, other dielectric materials, etc. within the scope of the present disclosure.

The baseplate 164 includes a threaded stud feature 168 (broadly, a mounting feature or fixture) for installing the antenna 100 to a ceiling (broadly, a mounting surface) with a plastic nut. The threaded stud feature 168 is generally hollow such that the feed cable 142 (e.g., coaxial cables, other transmission lines, etc.) may be fed through the hollow interior of the threaded stud feature 168 to the cable feed location 140 of the antenna 100. The feed cable 142 may be a low PIM rated coaxial cable to feed the antenna 100 for better PIM performance and low PIM rating. Alternatively, the feed cable 142 may be standard coaxial cables to feed the antenna 100 for a standard version of the antenna. As shown in FIGS. 4 and 5, the cable feed point 142 may be located at or towards a center of the PCB 104, radome 160 and baseplate 164. This allows the cable feed point 142 to be located within or overlap the hollow interior of the threaded stud feature 168, which may be located at about the center of the baseplate 164.

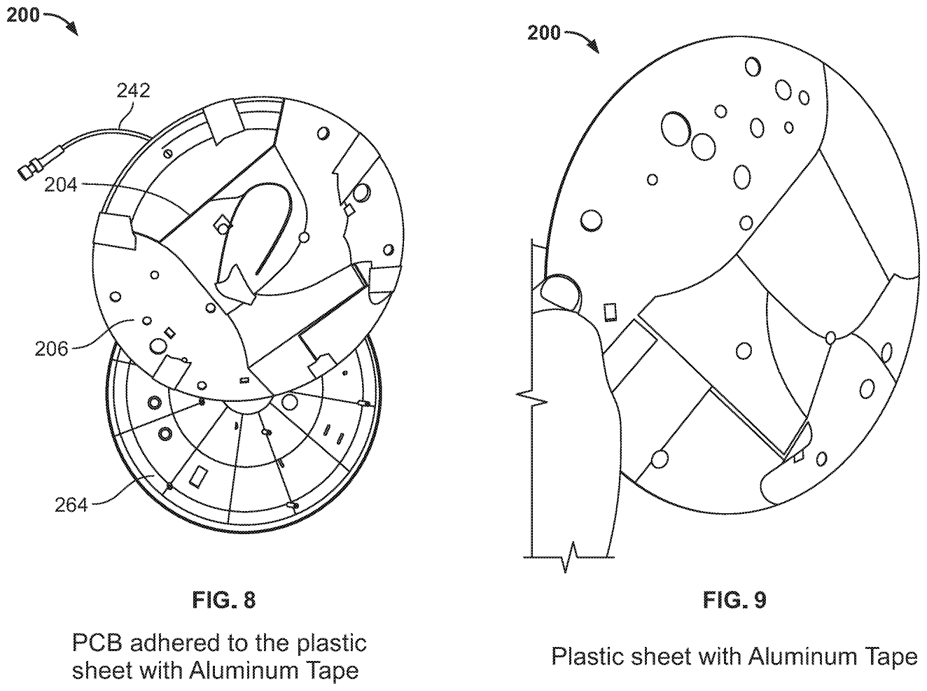

FIGS. 8, 9, and 10 illustrate another exemplary embodiment of an antenna 200 embodying one or more aspects of the present disclosure. The antenna 200 may be configured to be low profile and operable omnidirectionally within a ultra-wideband frequency range including frequencies from about 350 MHz to about 6000 MHz.

In this exemplary embodiment, the antenna 200 may have a hybrid or multi-piece construction including a low PIM rated PCB 204 and non-ferromagnetic foil 206 (e.g., aluminum foil, other metal foils, etc.) on a dielectric sheet 210 (e.g., plastic film, etc.). The low PIM rated PCB 204 may be relatively small and/or smaller in size than the PCB 104 of antenna 100.

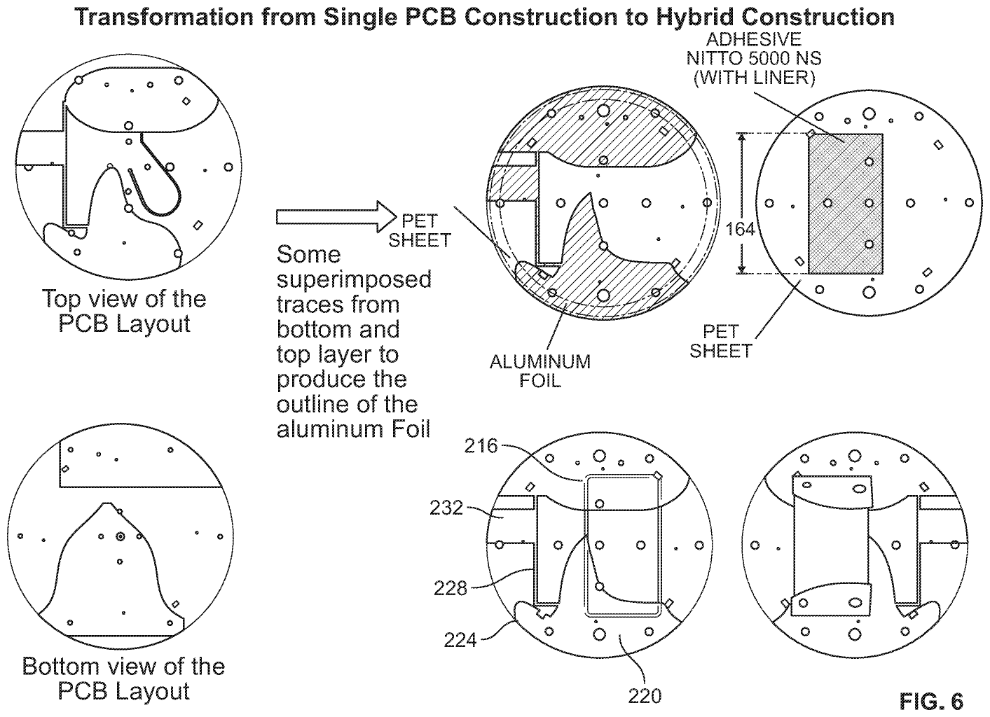

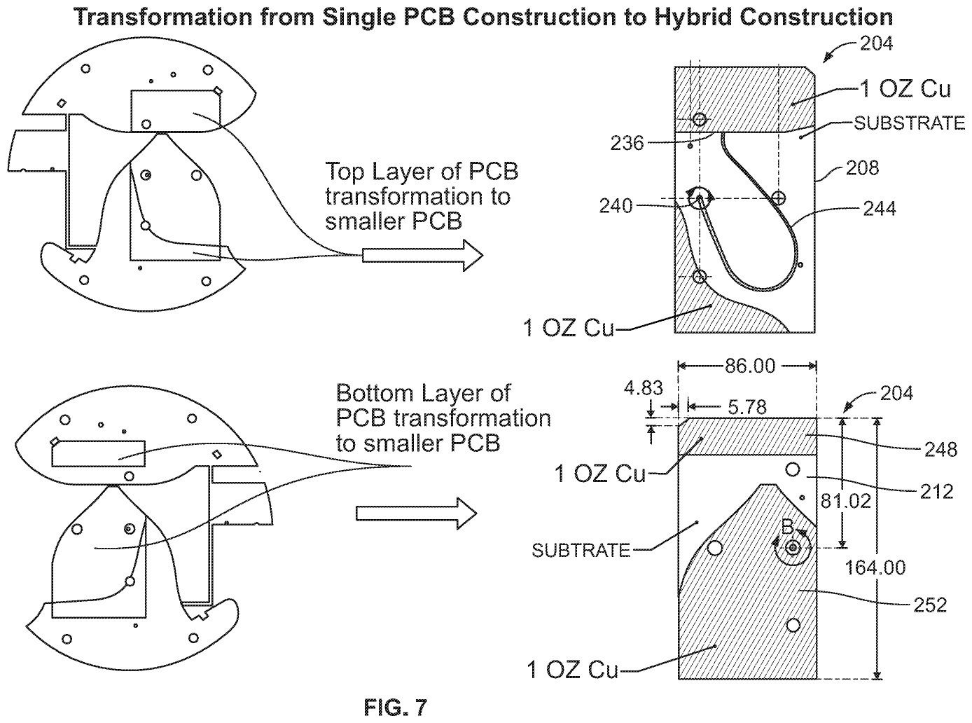

FIGS. 6 and 7 illustrate an exemplary transformation from the single PCB construction of antenna 100 (FIG. 2) to the hybrid construction of antenna 200 (FIG. 8) including the low PIM rated PCB 204 having electrically-conductive material thereon (e.g., copper traces, etc.) and non-ferromagnetic foil 206 (e.g., aluminum foil, etc.) on a dielectric sheet 210 (e.g., PET (polyethylene terephthalate) sheet, etc.). The dimensions in millimeters, weights in ounces, and specific materials (e.g., aluminum, PET (polyethylene terephthalate, etc.) are provided in FIGS. 6 and 7 as examples only according to an exemplary embodiment.

As shown in FIG. 6, aluminum foil or tape 206 may be used for a radiating element 216, a patch radiating element 220 with an additional radiating arm 224, a shorting line 228, and a stub 232 along the shorting line 228. The aluminum foil or tape 206 may be configured such that the radiating element 216, patch radiating element 220, additional radiating arm 224, shorting line 228, and stub 232 have features that correspond with and/or are similar to features of the radiating element 116, patch radiating element 120, additional radiating arm 124, shorting line 128, and stub 132.

As shown in FIG. 7, the PCB 204 includes a first or top side 208 and a second or bottom side 212 opposite the first side 208. The PCB's first side 208 includes electrically-conductive material thereon (e.g., copper, etc.) that corresponds to portions of the radiating element 116 and patch 120 of the antenna 100. The PCB's first side 208 includes a microstrip line 244 that extends between an antenna feed point 236 and a cable feed point 242. The microstrip line 244 is configured such that the microstrip line's width tapers or decreases along the microstrip line 244 in a direction from the cable feed point 240 to the antenna feed point 236. Accordingly, a width of the microstrip line 244 is larger at the cable feed point 240 and smaller at the antenna feed point 236.

The PCB's second side 212 includes electrically-conductive material thereon (e.g., copper, etc.) that corresponds to portions of the proximity patch 148 and the ground plane 152 of the antenna 100. The PCB's second side 212 includes a proximity patch 248 and a ground plane 252.

As shown in FIG. 10, the antenna 200 includes a radome or cover 260 (e.g., a plastic flat round or circular radome, etc.) and a baseplate or support member 264 (e.g., plastic baseplate, etc.). The radome 260 is circular with a diameter of 270 mm and low profile height of 7.6 mm. The baseplate 264 is also circular with a diameter of 270 mm. The dimensions in this paragraph and FIG. 10 (and elsewhere in this application and the drawings) are provided for purposes of illustration only according to exemplary embodiments as alternative embodiments may be configured differently, e.g., smaller, larger, etc.

The radome 260 and baseplate 264 cooperatively define an interior in which the PCB 204 may be positioned. The baseplate 264 may be configured for holding the antenna components. For example, the baseplate 264 includes a recess or pocket 272 configured for receiving the PCB 204 therein such that the PCB 204 is positioned correctly relative to the baseplate 264. This also allows the trace of the aluminum foil 206 to be loaded by both the dielectric baseplate 264 and the dielectric radome 26, which may help to slightly increase the antenna's electrical size. The baseplate 264 may include protrusions extending upwardly for positioning within corresponding openings in the PCB 204 and the aluminum foil 206 and plastic film 210, to thereby align and retain the PCB 204 and aluminum foil 206 in place.

The radome 260 and baseplate 264 are configured to protect the PCB 204, aluminum foil 206, and plastic film 210 from damage, e.g., due to environmental conditions, etc. The radome 260 and baseplate 264 may be formed from a wide range of materials, such as, for example, thermoplastic materials (e.g., polycarbonate blends, Acrylonitrile-Butadiene-Styrene (ABS), Polycarbonate-Acrylonitrile-Butadiene-Styrene Copolymer (PC/ABS) blend, etc.), glass-reinforced plastic materials, synthetic resin materials, other dielectric materials, etc. within the scope of the present disclosure.

The baseplate 264 includes a threaded stud feature 268 (broadly, a mounting feature or fixture) for installing the antenna 200 to a ceiling (broadly, a mounting surface) with a dielectric (e.g., plastic, etc.) nut. The threaded stud feature 268 is generally hollow such that the feed cable 242 (e.g., coaxial cables, other transmission lines, etc.) may be fed through the hollow interior of the threaded stud feature 268 to the cable feed location 240 of the antenna 200. The feed cable 242 may be a low PIM rated coaxial cable to feed the antenna 200 for better PIM performance and low PIM rating. Alternatively, the feed cable 242 may be standard coaxial cables to feed the antenna 200 for a standard version of the antenna. The cable feed point 242 may be located at or towards a center of the PCB 204, radome 260, and baseplate 264. This allows the cable feed point 242 to be located within or overlap the hollow interior of the threaded stud feature 268, which may be located at about the center of the baseplate 264.

Also shown in FIG. 10 are a low PIM connector 276 at an end of the cable 242. By way of example, the connector 276 may be coupled to the cable 242 via heat shrink tube 280, etc.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, specific shapes, and/or specific antenna operational performance data disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. For example, when permissive phrases, such as “may comprise”, “may include”, and the like, are used herein, at least one embodiment comprises or includes the feature(s). As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances (e.g., angle+/−30′, 0-place decimal+/−0.5, 1-place decimal+/−0.25, 2-place decimal+/−0.13, etc.). Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An antenna comprising a printed circuit board (PCB) having a first side and a second side opposite the first side, wherein:
the first side of the PCB includes a radiating element, a first patch with an additional radiating arm, a shorting line, a stub along the shorting line, and a microstrip line; and
the second side of the PCB includes a ground plane and a second patch.

2. The antenna of claim 1, wherein:
the radiating element is configured to have a non-rectangular shape; and
the ground plane is configured to have a non-rectangular shape.

3. The antenna of claim 2, wherein the non-rectangular shape of the radiating element and/or the non-rectangular shape of the ground plane are configured to enable the antenna to have a good transition of impedance across a wide frequency range.

4. The antenna of claim 1, wherein:
the radiating element is configured to have a generally elliptical shape; and
the ground plane is configured to have a generally bell shape.

5. The antenna of claim 1, wherein:
the radiating element, the first patch with the additional radiating arm, the shorting line, the stub, and the microstrip line comprise electrically-conductive traces along the first side of the PCB; and
the ground plane and the second patch comprise electrically-conductive traces along the second side of the PCB.

6. The antenna of claim 1, wherein:
the additional radiating arm, the shorting line, and the stub comprise electrically-conductive foil;
the radiating element comprises electrically-conductive foil and an electrically-conductive trace along the first side of the PCB that overlaps the electrically-conductive foil of the radiating element;
the first patch comprises electrically-conductive foil and an electrically-conductive trace along the first side of the PCB that overlaps the electrically-conductive foil of the first patch;
the ground plane comprises electrically-conductive foil and an electrically-conductive trace along the second side of the PCB that overlaps the electrically-conductive foil of the ground plane; and
the second patch comprises electrically-conductive foil and an electrically-conductive trace along the second side of the PCB that overlaps the electrically-conductive foil of the second patch.

7. The antenna of claim 6, wherein:
the electrically-conductive foil comprises aluminum foil or tape; and/or
the PCB and the electrically-conductive foil are on a dielectric sheet or film; and/or
the electrically-conductive foil comprises electrically-conductive tape that adheres the PCB to a dielectric sheet or film.

8. The antenna of claim 1, wherein:
the radiating element is configured to be generally elliptical shaped; and
the ground plane is configured to be generally bell shaped; and
the generally elliptical shape of the radiating element and the generally bell shape of the ground plane enable the antenna to have a good transition of impedance across a wide frequency range.

9. The antenna of claim 1, wherein the shorting line extends generally between the radiating element and the first patch.

10. The antenna of claim 1, the additional radiating arm and the second patch are configured to increase an electrical length of the antenna.

11. The antenna of claim 10, wherein the increased electrical length of the antenna provided by the additional radiating arm and the second patch allows the antenna to have a VSWR of less than 2 at lower frequencies including a frequency of at least 380 MHz.

12. The antenna of claim 1, wherein:
the first side of the PCB further includes a feed point for the antenna and a cable feed point;
the microstrip line extends generally between the antenna feed point and the cable feed point; and
the microstrip line is configured such that a width of the microstrip line tapers or decreases along the microstrip line in a direction from the cable feed point to the antenna feed point, whereby a width of the microstrip line is larger at the cable feed point and smaller at the antenna feed point.

13. The antenna of claim 1, wherein the first patch along the first side of the PCB is configured to proximity couple to the ground plane along the second side of the PCB.

14. The antenna of claim 1, wherein the stub is configured to allow the antenna to have a VSWR of less than 2 at lower frequencies including a frequency of at least 380 MHz.

15. The antenna of claim 1, wherein:
the antenna comprises a baseplate and a radome coupled to the baseplate; and
the PCB, the radiating element, the first patch with the additional radiating arm, the shorting line, the stub along the shorting line, the microstrip line, the ground plane, and the second patch are within an interior cooperatively defined between the radome and the baseplate.

16. The antenna of claim 15, wherein:
the baseplate and the radome are each circular with a diameter of about 270 mm or less; and
an overall height of the radome and the baseplate is about 7.6 millimeters or less when the radome is coupled to the baseplate.

17. The antenna of claim 1, wherein the antenna comprises an asymmetrical arm shorted dipole.

18. The antenna of claim 1, wherein the antenna comprises a planar shorted discone antenna.

19. The antenna of claim 1, wherein the antenna is configured such that the antenna is low profile and configured to be operable omnidirectionally within an ultra-wideband frequency range including frequencies from about 350 megahertz to about 6000 MHz.

20. The antenna of claim 1, wherein:
the antenna is configured to be operable with a VSWR of less than 2 across an ultra-wideband frequency range including frequencies from about 350 megahertz to about 6000 MHz;
and/or the antenna is configured to be operable with a passive intermodulation (PIM) level less than −150 decibels relative to carrier for an ultra-wideband frequency range including frequencies from about 350 megahertz to about 6000 MHz.
